(19) United States
(12) Patent Application Publication
(10) Pub. No.: US 2013/0000403 A1
(43) Pub. Date: Jan. 3, 2013

(54) DEVICE FOR DETECTING SHIFTED POSITIONS

(75) Inventors: Frank Mai, Eberdingen (DE); Vahid Seyed-Khoei, Fellbach (DE)

(73) Assignee: Robert Bosch GMBH, Stuttgart (DE)

(21) Appl. No.: 13/515,775

(22) PCT Filed: Nov. 25, 2010
(86) PCT No.: PCT/EP10/68260

§ 371 Date: Sep. 10, 2012

(30) Foreign Application Priority Data
Dec. 16, 2009 (DE) 10 2009 054 733.9
Apr. 28, 2010 (DE) 10 2010 028 337.1

(51) Int. Cl. G01D 11/24; B32B 37/24; B29C 47/06

(52) U.S. Cl. 73/431; 264/241; 156/244.11

(57) ABSTRACT

A device for detecting a shifted position of a lever includes a sensor package, relative to which a magnetic carriage is displaceable, which sensor package is accommodated in a sensor housing. An air gap between the sensor package and the side of the magnetic carriage facing the sensor package is minimized using inserts which are integrated into the sensor housing.

### BACKGROUND OF THE INVENTION

1. Field of the Invention

The present invention relates to a device for detecting a shifted position of a lever, which device includes a housing, a sensor package and a magnetic carriage.

2. Description of the Related Art

Published German patent application document DE 10 2006 059 741 A1 relates to a modularly designed sensor carrier assembly. The sensor carrier assembly includes at least one basic housing and at least one sensor carrier module manufactured separately therefrom. The sensor carrier module is manufactured from casting-compatible material and is mechanically attached to the basic housing of the sensor carrier assembly.

When used in motor vehicles, in particular in position sensors for a transmission controller, the sensors are built integrated into electronic modules. Position sensors in automatic transmissions must resist ambient temperatures between −40° C. and +150° C. and the aggressive surrounding medium (ATF=automatic transmission fluid), high mechanical stresses up to 30 g and metallic wear and particle build-up in the transmission.

Resistance to media and temperature is ensured in these applications by an oil-resistant encapsulation of the electronics and the use of high-temperature printed circuit boards. Due to the complex requirements of different transmission topologies, as well as installation space and function requirements, different physical measurement principles are used. A linear position detection may take place, for example, on the basis of Hall switches. In this context, one or more digital Hall switches are used, which are situated on a printed circuit board in such a way that they detect the magnetic encoding of a linearly displaceable multi-pole permanent magnet. A magnetic carriage is coupled to a linearly activated selector lever, a hydraulic slide in the transmission control board or a park-lock cylinder. Resistors for showing the diagnosis functions and EMC capacitors are located on the printed circuit board in addition to the Hall switches.

The sensor electronics is protected against the influences of the transmission oil by a thick, oil-resistant epoxy resin encapsulation. With an automatic transmission having manual shifting, also known as M shifting, the position sensor detects the positions P, R, N, D, 4, 3, and 2 of the selector lever as well as the areas in between. These are output to the transmission controller, for example, in the form of a 4-bit code, the use of four Hall switches being required in this case. For safety reasons, the encoding of the position setting may be designed in one step, i.e., only one bit change is allowed from one range to the other. From one selector lever position to the other, two bits are always changed, for example, from P to R via intermediary position Z1. Single bit changes caused by a malfunction may be recognized by the control unit as erroneous with the aid of plausibility checking. The structure of position sensors of this type for transmission controllers is known from the publication “Sensoren im Kraftfahrzeug” [Sensors in Motor Vehicles], Robert Bosch GmbH, Ed. 2007, Fachwissen Kfz-Technik, Elektrik und Elektronik für Kfz, ISBN-10 3-7782-2031-4, pp. 136-138.

### BRIEF SUMMARY OF THE INVENTION

Following the approach proposed according to the present invention, it is proposed, for increasing the detection accuracy, to minimize an air gap between a magnetic carriage that is laterally displaceable on a sensor housing and a sensor package integrated into the sensor housing by integrating inserts, in particular soft-magnetic inserts, into the material of the sensor housing. The magnetic carriage is attracted toward the sensor package by the inserts, so that the air gap between the inside of the magnetic carriage which is laterally displaceable along the housing and the side of the sensor package facing the magnetic carriage, viewed along the displacement path of the magnetic carriage, is drastically diminished.

The magnetic carriage, which is displaceable along at least one guide rib on the sensor housing of the sensor, has, on its side facing the sensor package, a number of magnetic strips, which are integrated into the plastic material from which the magnetic carriage is preferably manufactured. The individual magnetic strips contain individual encoding patterns, in particular pole transitions, and may be separated from one another on the inside of the magnetic carriage facing the sensor package of the sensor housing of the sensor, for example, by individual ribs.

In a particularly simple manner from the manufacturing point of view, the inserts may be inserted directly into the corresponding openings in the sensor housing during the manufacture of the sensor housing and extrusion coated by the plastic material during the manufacture of the sensor housing in one single process step. The inserts are located in the sensor housing, into which the sensor package is integrated, forming a minimum edge distance to a window, before the extrusion coating of the sensor housing, for example having an integrated lead frame system and a sensor housing made of another material, for example, PA plastic material, is finished. The inserts may have a height, in particular, which exceeds their width several times. By situating the inserts in parallel to the height of the window for accommodating the sensor package in the sensor housing, it is ensured that the air gap between the inside of the displaceable magnetic carriage and the side of the sensor package facing it in the sensor housing is minimized exactly when the magnetic strip to which the bit patterns to be detected are applied passes along the side of the sensor package facing it.

In a particularly advantageous manner, the openings for accommodating the inserts extend, as mentioned previously, in parallel to the height of the window, in particular between the vertical edge-oriented sides of the window and the openings used for forming claws between the sensor housing and another plastic layer that may surround it.

While the sensor housing is manufactured from a plastic material such as PPS (polyphenyl sulfide), which has a very high dimensional stability, it may also be manufactured from a cost-effective plastic material such as PA (polyamide) for protecting the sensor package and a lead frame.

In addition to the embodiment option of injecting the inserts directly into the appropriate openings at the time the sensor housing made of PPS is manufactured, there is also the option of providing openings, into which the inserts may be glued, caulked, or otherwise attached in a subsequent process step, during the injection molding process of the sensor housing made of PPS material. The inserts are attached in the appropriate openings next to the window for accommodating the sensor package in the sensor housing in such a way that thermal expansions due to changes in temperature do not affect the positional accuracy of the inserts. It is to be taken into account that the sensor housing of the sensor proposed according to the present invention, which is used in particular for detecting the position of a selector lever of a controller of an automatic transmission, is operated in a temperature range between −40° C. and +150° C. The expansions of the sensor housing of the sensor according to the present invention occurring during these extreme temperature fluctuations is to be taken into account when dimensioning the openings for accommodating the inserts in order to ensure reliability performance, i.e., minimization of the air gap during movements of the selector lever of an automatic transmission over its lifetime.

### BRIEF DESCRIPTION OF THE DRAWINGS

FIG. 1 shows a sensor housing of a sensor having a magnetic carriage movably accommodated therein.

FIG. 2 shows a view of the inside of the magnetic carriage which is movable laterally in the sensor housing according to the illustration in FIG. 1.

FIG. 3 shows a top view onto the sensor window covered by the displaceable magnetic carriage accommodated in the sensor housing in FIG. 1.

FIG. 4 shows an illustration of the configuration of inserts and the formation of a minimum edge section next to the window for accommodating the sensor package.

FIG. 5 shows the magnetic carriage displaceable along a displacement path on the sensor housing, one of the inserts being still just exposed.

### DETAILED DESCRIPTION OF THE INVENTION

In the description that follows, sensor housing 12 of sensor 10 proposed according to the present invention is manufactured from a plastic material, which has a high dimensional stability. Polyphenyl sulfide (PPS) has been found suitable for this purpose. An extruded plastic sheath covering sensor 10 and sensor housing 12, as well as lead frame 16 and sensor package 72 accommodated in the sensor housing, is preferably manufactured from a less expensive plastic material such as polyamide (PA). Instead of lead frame 16, any other connecting technology suitable for electrical contacting is also possible.

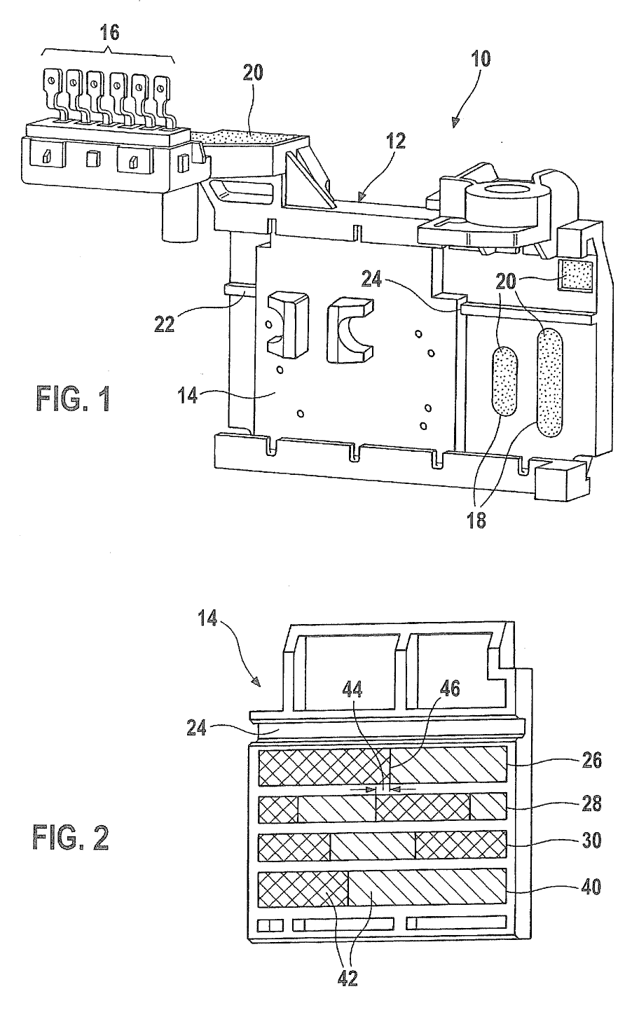

The illustration according to FIG. 1 shows a sensor housing on which a magnetic carriage may be displaced. In this exemplary embodiment, four Hall switches are, for example, installed in sensor package 72, in sensor housing 12 so that the sensor signal is output in the form of a 4-bit code.

From the illustration according to FIG. 1, it is apparent that a sensor 10 includes a sensor housing 12, which is manufactured from a dimensionally stable plastic such as polyphenyl sulfide (PPS). A magnetic carriage is displaceable in the lateral direction on sensor housing 12. A contact 16 of a lead frame integrated into the sensor housing protrudes from sensor housing 12. Openings 18 into which a PA extrusion coating 20 (PA=polyamide) forms claw points in a further extrusion process are provided in sensor housing 12. This means that, in a further extrusion process of sensor housing 12, openings 18, together with sensor package 72 (not illustrated in FIG. 1) and the integrated lead frame which are accommodated therein, are extrusion coated by plastic material, in particular polyamide, which, in the fluid state, passes through openings 18 and thus forms an integral, form-locked connection to sensor housing 12 of sensor 10.

The illustration according to FIG. 1 also shows that a guide rib 22 extends on the inside of sensor housing 12, facing magnetic carriage 14 displaceably situated thereon. Guide rib 22 protrudes into guide groove 24 of magnetic carriage 14. The geometries of guide rib 22 of sensor housing 12 and guide groove 24 on the inside of magnetic carriage 14 are complementary to each other.

The illustration according to FIG. 2 shows a top view onto the inside of magnetic carriage 14, which is displaceably accommodated on sensor housing 12 according to FIG. 1.

From the illustration according to FIG. 2 it is apparent that magnetic strips 26, 28, 30, and 40, extending essentially in parallel to one another, are located on the inside of magnetic carriage 14. Each magnetic strip 26, 28, 30, and 40 carries an encoding pattern 42. Each encoding pattern 42 of each magnetic strip 26, 28, 30, and 40 differs from the other encoding patterns and contains at least one pole transition 46.

Regarding first magnetic strip 26 and second magnetic strip 28 on the inside of magnetic carriage 14, it should be remembered that the north-south pole transitions on the individual magnetic strips are in general independent of the position of the pole transitions of the adjacent strips. An overlap 44 may occur if north-north and/or south-south areas are adjacent. The extrusion coating is produced from non-metallic material between magnetic strips 26, 28, 30, 40. The transitions between north pole and south pole of a magnetic strip 26, 28, 30, 40 are detected by a Hall IC. Depending on the position of the poles, a 4-bit signal is output; for example, when the selector lever is in the P position, a code 0010 is generated.

The illustration according to FIG. 2 shows that magnetic strips 26, 28, 30, and 40 may have different heights and may be separated from one another by plastic webs.

Guide groove 24, which cooperates with guide rib 22 of sensor housing 12 of sensor 10, runs on the inside of magnetic carriage 14 according to the top view of FIG. 2.

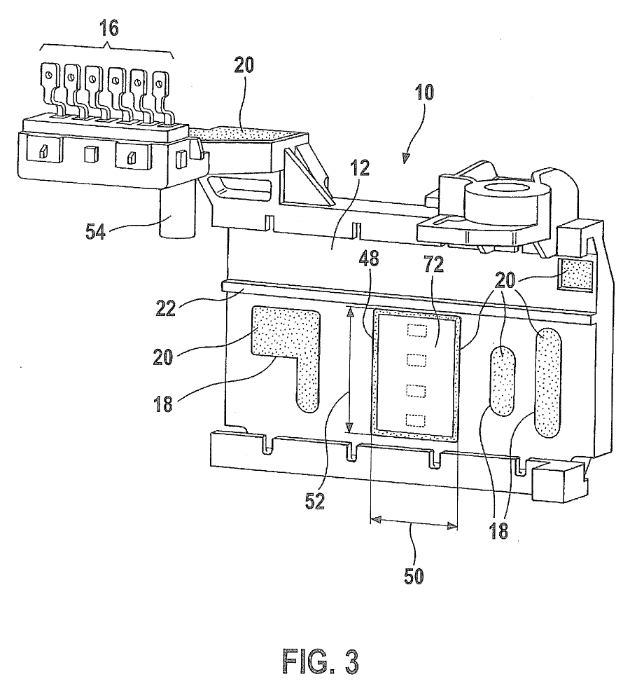

The illustration according to FIG. 3 shows a perspective top view onto the sensor housing of the sensor, in which the magnetic carriage has been removed.

FIG. 3 shows that a window 48 is formed in sensor housing 12 between openings 18 for forming the claws between PA extrusion coating 20 and sensor housing 12. The perspective illustration according to FIG. 3 shows that window 48, which is used for accommodating a sensor package 72, has a width 50, which in the illustration according to FIG. 3 is somewhat smaller than a height 52 of window 48.

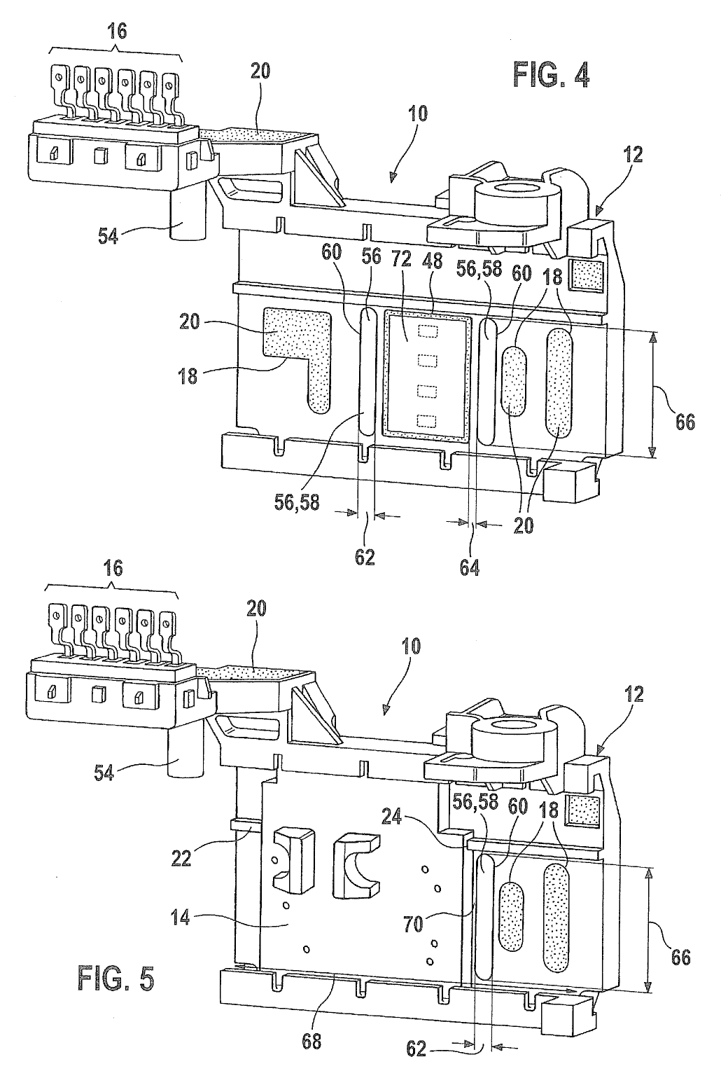

Receptacle openings 60 for soft-magnetic inserts 56 illustrated in FIG. 4 are parallel to height 52 of window 48 in sensor housing 12 according to the illustration of FIG. 3. This allows a minimum distance to be observed to vertical edge 52 of window 48 with respect to openings 18 in the wall of sensor housing 12, in which PA extrusion coating 20 forms claw points or claw elements.

Although in the illustration according to FIG. 3 window 48 has an essentially rectangular geometry and its height is somewhat greater than its width 50, window 48 may also have a greater width 50 compared to its height 52. This depends on the size of sensor package 72 to be installed and on the requirements regarding a certain longitudinal coating of the displacement path of magnetic carriage 14 with respect to sensor package 72.

FIG. 4 shows an embodiment variant of the sensor housing having inserts situated next to the window for accommodating the sensor package.

The illustration according to FIG. 4 shows that sensor housing 12 of sensor 10 illustrated therein is essentially identical to sensor housing 12 illustrated in FIG. 3. Unlike the illustration according to FIG. 3, receptacle openings 60 extending essentially in parallel to the vertical edge of window 48 run next to window 48 for accommodating sensor package 72. Receptacle openings 60 are at a minimum edge distance 64 with respect to window 48. The smaller edge distance 64 between receptacle openings 60 for inserts 56 with respect to the edges of window 48 can be kept, the smaller air gap 70 will be between the inside of displaceable magnetic carriage 14 and the flat side of sensor package 72 facing it.

In the illustration according to FIG. 4, receptacle openings 60 for accommodating the inserts have an essentially elongated-hole shape. Other geometries, such as, for example, rectangular geometry, are also possible. Instead of single-piece inserts 56 according to the embodiment variant of FIG. 4, other insert geometries, such as cylindrical or rod-shaped geometries, may also be installed in receptacle openings 60. In one possible embodiment variant for attaching inserts 56 in receptacle openings 60, the inserts may be configured, for example, during a manufacturing process of sensor housing 12, in receptacle openings 60, enclosed by the plastic material, i.e., PPS material, from the injection molding tool, and thus directly integrated into sensor housing 12. Due to the high dimensional stability of the PPS material, inserts 56 are reliably fixed in the particular receptacle openings 60.

On the other hand, there is also the option of prefabricating only receptacle openings 60 when sensor housing 12 is manufactured and, in a subsequent process step, to fix inserts 56 in these openings by gluing or pressing in, for example.

The illustration according to FIG. 4 furthermore shows that, for example, a height 66 of inserts 56 exceeds their width 62 several times. The greater the extension of inserts 56 in the vertical direction, the more air gap 70 between the inside of magnetic carriage 14 and the longitudinal side of sensor package 72 may be minimized by the approach proposed according to the present invention.

The illustration according to FIG. 4 also shows that receptacle openings 60 for inserts 56 may be placed, in a particularly advantageous manner, between openings 18 for the later formation of the claw points of PA extrusion coating 20 and the vertical edges of window 48 for accommodating sensor package 72. Reference numeral 54 identifies a bushing, which may have an internal thread, for fixing sensor housing 12 to the housing of the controller of an automatic or semiautomatic vehicle transmission. Inserts 56 are made of soft-magnetic material 58. Soft-magnetic material is understood as a ferromagnetic material which is easy to magnetize in a magnetic field, but, unlike a hard-magnetic material, is not a permanent magnet. Iron is an example of a soft-magnetic material.

FIG. 4 shows that, for example, the top of sensor housing 12 of sensor 10 is enclosed by PA extrusion coating 20, and that PA extrusion coating 20 has also penetrated openings 18 in the lateral surface of sensor housing 12 and has formed claw points there for the integral and form-locked connection between PA extrusion coating 20 and sensor housing 12, which is preferably made of PPS.

Following the approach proposed according to the present invention, sensor package 72 is, in particular, integrated into sensor housing 12 in such a way that its flat side is in the plane of the housing side of the sensor housing, i.e., extends over it as little as possible, which favors further minimization of air gap 70 between magnetic carriage 14 and the flat side of sensor package 72. A minimum air gap 70 between the inside of magnetic carriage 14 and the flat side of sensor package 72 must be maintained in order to prevent grinding, i.e., mechanical contact, between the inside of magnetic carriage 14 and the flat side of sensor package 72 under any circumstances.

The perspective illustration according to FIG. 5 shows that a magnetic carriage 14 is mounted into sensor housing 12, which has a design similar to that of the sensor housing according to FIG. 5. As already described in FIG. 2, magnetic carriage 14 contains, on a side facing the flat side of sensor package 72, magnetic strips 26, 28, 30, and 40, each of which includes encoding patterns 42.

As is apparent from the illustration according to FIG. 5, magnetic carriage 14 is guided on guide rib 22 and is displaceable relative to the sensor housing along a displacement path identified by reference numeral 68.

The lateral expansion of displacement path 68 is measured in such a way that it is sufficient for the different encoding patterns 42 on magnetic strips 26, 28, 30, 40 and on the inside of magnetic carriage 14 to be reliably recognized by sensor package 72.

FIG. 5 furthermore shows that the position of magnetic carriage 14 is selected there in such a way that one side of magnetic carriage 14 just fails to cover one of inserts 56, which are made of soft-magnetic material 58 in particular. The portion of inserts 56 covered by magnetic carriage 14 attracts magnetic carriage 14 to sensor housing 12, forming a minimized air gap 70.

Inserts 56, which are parts made of soft-magnetic material 58 in particular, have a height 66, which exceeds its width 62 several times. Inserts 56 preferably made of soft-magnetic material 58 do not affect magnetic strips 26, 28, 30, 40, which are formed on the inside of magnetic carriage 14 because a safety distance is implemented between the pole transitions in the height of the IC and inserts 56.

Sensor housing 12 of sensor 10 illustrated in FIG. 5 also includes a lead frame system, of which only contacts 16 may be recognized here. As is also apparent from the illustration according to FIG. 5, the material of PA extrusion coating 20 has penetrated openings 18 on the wall of sensor housing 12, forming claw points between PA extrusion coating 20 and sensor housing 12, which is usually manufactured from a dimensionally stable plastic material such as polyphenyl,sulfide (PPS), for example.

1-10. (canceled)

11. A device for detecting a shifted position of a lever, comprising:
a sensor package;
a sensor housing accommodating the sensor package; and
a magnetic carriage displaceable relative to the sensor package;
at least one insert which is inserted into the sensor housing, wherein an air gap between the sensor package and a side of the magnetic carriage facing the sensor package is minimized by the at least one insert.

12. The device as recited in claim 11, wherein the at least one insert is made of soft-magnetic material.

13. The device as recited in claim 11, wherein the at least one insert is situated in the sensor housing, and wherein the distance between the at least one insert and an edge of a window in the sensor housing for the sensor package is minimized.

14. The device as recited in claim 13, wherein the at least one insert extends in parallel to the height of the window in the sensor housing.

15. The device as recited in claim 11, wherein the magnetic carriage includes multiple magnetic strips on the side of the magnetic carriage facing the sensor package.

16. The device as recited in claim 11, wherein the height of the at least one insert exceeds the width of the at least one insert.

17. The device as recited in claim 11, wherein the at least one insert is essentially in the plane of the sensor housing facing the magnetic carriage.

18. The device as recited in claim 11, wherein the at least one insert is connected to a receptacle opening in the sensor housing in a form-locked manner by one of gluing into the receptacle opening, pressing into the receptacle opening, or extrusion coating by the material of the sensor housing.

19. The device as recited in claim 11, wherein the at least one insert is situated between (i) an opening in the sensor housing for a polyamide extrusion coating of the sensor housing and (ii) a window in the sensor housing for the sensor package.

20. A method for manufacturing a device for detecting a shifted position of lever, comprising:
a) producing a sensor housing from a dimensionally stable plastic material, wherein a window in the sensor housing is provided for accommodating a sensor package;
b) producing at least one receptacle opening in the sensor housing next to the window;
c) producing at least one opening for forming a claw element of a polyamide extrusion coating during an extrusion process for the sensor housing; and
one of: d₁) extrusion coating of at least one insert during method step a), or d₂) pressing, gluing, or caulking the at least one insert into a receptacle opening in the sensor housing.
